(19) United States
(12) Patent Application Publication
(10) Pub. No.: US 2022/0312102 A1
(43) Pub. Date: Sep. 29, 2022

(54) HEADSETS OF COMPUTING DEVICES

(71) Applicant: Hewlett-Packard Development Company, L.P., Spring, TX (US)

(72) Inventors: Jose Ticy Lo, Spring, TX (US); Chan Woo Park, Spring, TX (US)

(73) Assignee: Hewlett-Packard Development Company, L.P., Spring, TX (US)

(21) Appl. No.: 17/615,598

(22) PCT Filed: Sep. 26, 2019
(86) PCT No.: PCT/US2019/053235

§ 371 Date: Dec. 1, 2021

(51) Int. Cl. H04R 1/10

(52) U.S. Cl. CPC H04R 1/1016; H04R 1/1025; H04R 1/1058

(57) ABSTRACT

An example system includes a headset and a computing device including a housing, the housing including a compartment for accommodating the headset. As an example, the headset includes a first member, and a second member that is foldable with respect to the first member of the headset, between an unfolded position and a folded position.

### BACKGROUND

A headset generally combines a headphone with a microphone, providing the equivalent functionality of a telephone handset but with handsfree operation, providing the ability for a user to have both hands free during a telephone conversation or teleconference. With regards to teleconferences, a user may utilize a headset wirelessly connected to a computing device, in order to communicate with other users via their respective computing devices, all linked by a telecommunications system. The telecommunications system may support the teleconference by providing one or more of audio, video, and/or data services.

### BRIEF DESCRIPTION OF THE DRAWINGS

FIGS. 1A-B illustrate a headset that is stowable in a computing device, according to an example;

FIGS. 2A-B illustrate the headset switching between an unfolded position and a folded position, according to an example;

FIGS. 3A-C illustrate a system including the headset and computing device, particularly while the headset is stowed away in the computing device, according to an example;

FIGS. 4A-B illustrate a headset 420 that is stowable in a housing of a computing device, according to an example;

FIGS. 5A-B illustrate the headset switching between an unfolded position and a folded position, according to an example; and

FIGS. 6A-C illustrate a system including the headset and housing of computing device, particularly while the headset is stowed away in the computing device, according to an example.

### DETAILED DESCRIPTION

Examples disclosed herein provide the ability to stow away a headset into a computing device, for example, while the headset is not being used. While the headset is stored, for example, in a compartment of the computing device, a user may have easy access to the headset whenever it is required, rather than carrying the headset separately from the computing device. In addition, rather than carrying a cable to charge the headset when its battery is low, which may occupy a port on the computing device during charging, the computing device may include a charging mechanism that charges the headset while it is stowed away in the compartment of the computing device. As a result, rather than being utilized for charging the headset, the port becomes available for other uses.

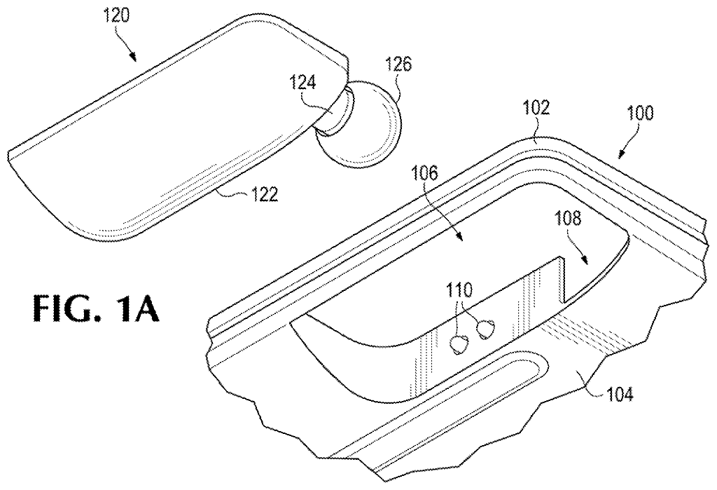

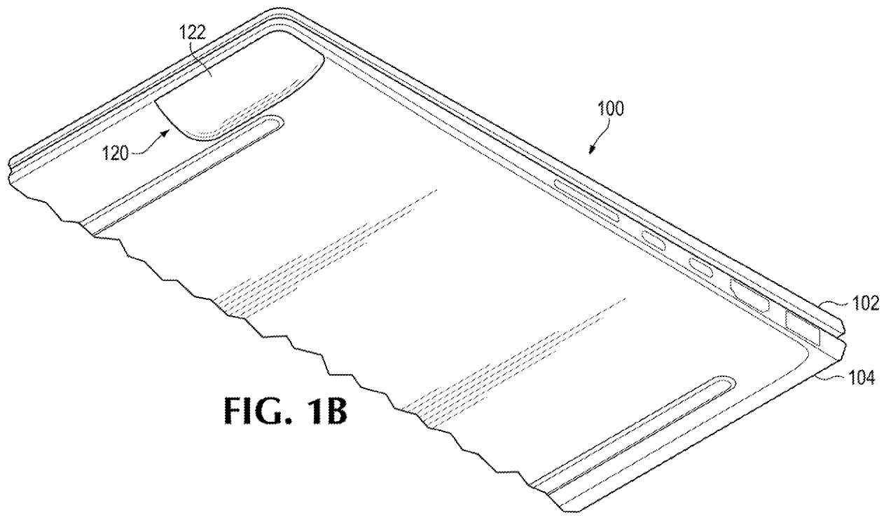

With reference to the figures. FIG. 1A illustrates a headset 120 that is stowable in a computing device 100, according to an example. As an example, the computing device 100 may correspond to a notebook computer that includes various housings, such as a display member 102 and a base member 104 rotatably connected to the display member 102. The headset 120 may be stowed in either housing, and is not limited to the base member 104 as illustrated. In addition, the computing device 100 may correspond to other devices besides a notebook computer. As illustrated, the base member 104 of the computing device 100 may include a compartment 106 for accommodating the headset 120, As will be further described, the compartment 106 may include an additional compartment 108 for accommodating an earpiece 126 of the headset 120. In addition, the computing device 100 may include a charging mechanism 110, such as pogo pins, for keeping the headset 120 charged while it is stowed, and a mechanism for securing the headset 120 to the computing device 100 while it is stowed, such as a magnetic member (not illustrated).

Referring to the headset 120, the headset 120 may include a first member 122 and a second member 124. As will be further described, the second member 124 may be foldable with respect to the first member 122 of the headset 120, between an unfolded position and a folded position. As illustrated, the second member 124 of the headset 120 may include an earpiece 126. In addition, the headset may include contacts (not illustrated) for mating with the charging mechanism 110 while the headset 120 is stored within the compartment 106 of the computing device 100. In addition, the headset 120 may include a mechanism for ensuring that the headset 120 remains secured to the computing device 100 while it is stowed, such as a magnetic member (not illustrated) to magnetically attach to a magnetic member disposed within the base member 104 of the computing device 100. FIG. 1B illustrates the headset 120 stowed away within the computing device 100, according to an example. As illustrated, the form factor of the headset 120 may allow for it to blend in with the form factor of the computing device 100, particularly the front bottom corner of the base member 104, in order to provide a seamless look.

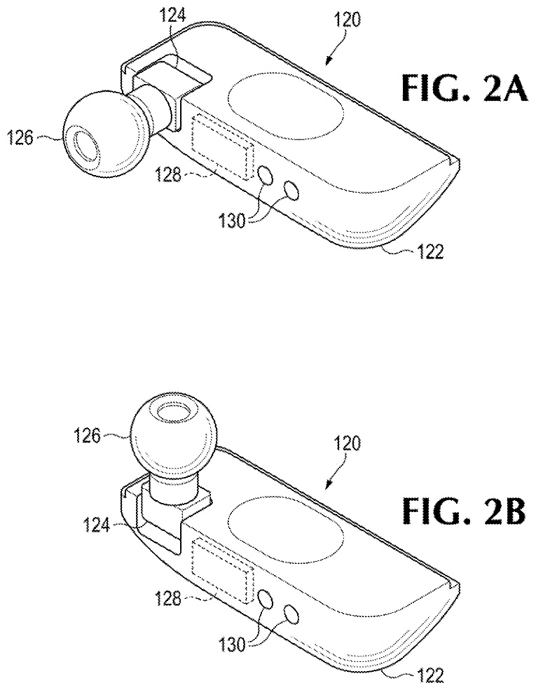

FIGS. 2A-B illustrate the headset 120 switching between an unfolded position and a folded position, according to an example, Referring to FIG. 2A, while in the unfolded position, the second member 124 of the headset 120 may be linearly aligned with the first member 122 of the headset 120. While in the unfolded position, the headset 120 may be stowed away in the computing device 100, as will be further described, Referring to FIG. 2B, while in the folded position, the headset 120 may be usable by a user for handsfree communications. For example, the earpiece 126 may be insertable in the ear, and a microphone (not illustrated) may be disposed along the first member 122 of the headset 120. The mechanism on the headset 120 for switching between the unfolded and folded positions may vary. For example, the headset 120 may include a hinge between the first member 122 and second member 124 to fold the second member 124 flat (i.e., unfolded position illustrated in FIG. 2A) or to fold the second member 124 to a comfortable position to be utilized by the user (i.e., folded position illustrated in FIG. 2B). Other mechanisms for switching between the unfolded and folded positions include, but are not limited to, a foldable metal. For example, the first and second members 122, 124 may be a single piece that includes a foldable metal to switch between the unfolded and folded positions.

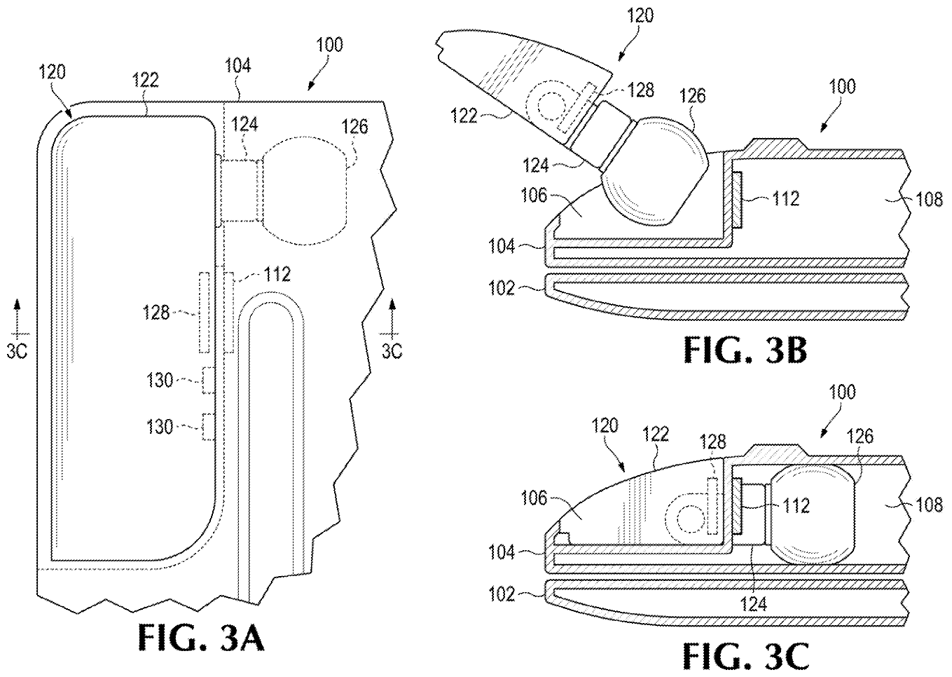

As an example, the headset 120 may include charging contacts 130 to mate with the charging mechanism 110 illustrated in FIG. 1A, in order to keep the headset 120 charged while it is stowed in the computing device 100. As a result, rather than relying on a charging cable to charge the headset 120, for example, via a port of the computing device 100, the port is made available for other uses and the headset 120 can be charged via the charging mechanism 110 while stowed. In addition, the headset 120 may include a magnetic member 128, for example, disposed within the first member 122, to magnetically attach to a magnetic member disposed within the computing device 100 (e.g., magnetic member 112 in FIGS. 3A-C), during storage of the headset 120 within compartment 106 of computing device 100. The placement and number of magnetic members utilized between the headset 120 and computing device 100 may vary from what is illustrated. In addition, rather than magnetic members, other mechanisms may be utilized to ensure that the headset 120 remains secured to the computing device 100 while the headset 120 is stowed.

FIGS. 3A-C illustrate a system including the headset 120 and computing device 100, particularly while the headset 120 is stowed away in the computing device 100, according to an example. Referring to FIG. 3A, portions of the headset 120 and computing device 100, particularly the base member 104, are illustrated in phantom, to provide details how the headset 120 is secured to the computing device 100, While in the unfolded position, a magnetic member 112 disposed within the housing (e.g., base member 104) of the computing device 100 may be utilized to magnetically attach to magnetic member 128 disposed within the headset 120, while the headset 120 is stowed away in the compartment 106 of the computing device 100, In addition, while stowed away, charging contacts 130 may mate with charging mechanism 100 (not illustrated), in order to keep the headset 120 charged.

Referring to FIG. 3B, while the headset 120 is in an unfolded position, the headset 120 is insertable into the compartment 106 of the computing device 100 via the second member 124 of the headset 120. Once fully stowed away, compartment 108 may accommodate earpiece 126 of the headset 120. Referring to FIG. 3C, while the headset 120 is stored within the compartment 106 of the computing device 100, the earpiece 126 may be compressible, for example, to fit within compartment 108.

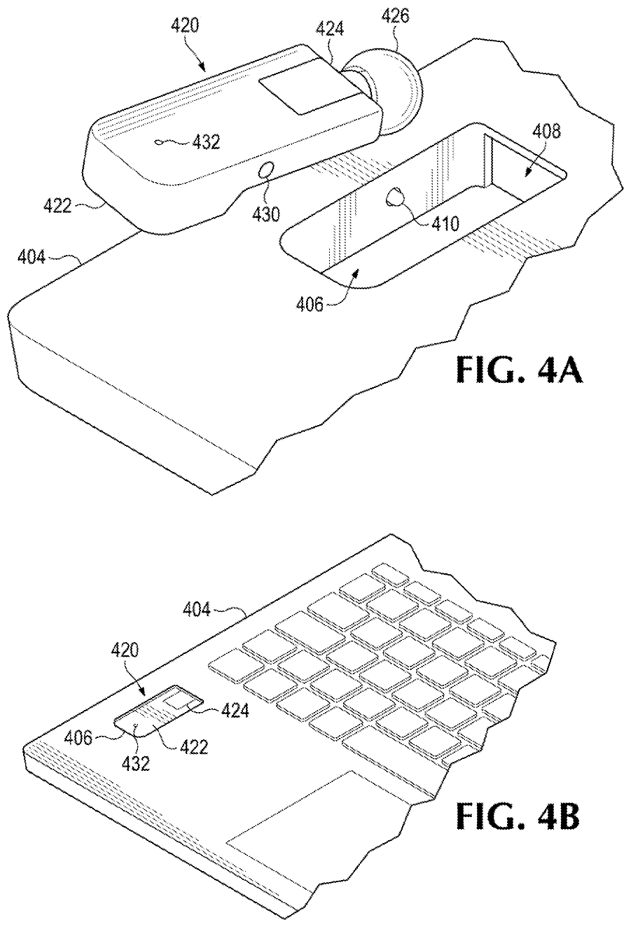

With reference to the figures, FIG. 4A illustrates a headset 420 that is stowable in a housing 404 of a computing device, according to an example. As an example, the computing device 400 may correspond to a notebook computer that includes various housings, such as a display member and a base member rotatably connected to the display member. The headset 420 may be stowed in either housing. In addition, the computing device 400 may correspond to other devices besides a notebook computer, such as a tablet computer. As illustrated, the housing 404 of the computing device may include a compartment 406 for accommodating the headset 420. As will be further described, the compartment 406 may include an additional compartment 408 for accommodating an earpiece 426 of the headset 420. In addition, the computing device may include a charging mechanism 410, such as pogo pins, for keeping the headset 420 charged while it is stowed, upon making contact with charging contacts 430 of the headset 420. As will be further described, the housing 404 of the computing device may include a mechanism for securing the headset 420 to the computing device while it is stowed.

Referring to the headset 420, the headset 420 may include a first member 422 and a second member 424. As will be further described, the second member 424 may be foldable with respect to the first member 422 of the headset 420, between an unfolded position and a folded position. As illustrated, the second member 424 of the headset 420 may include an earpiece 426. As mentioned above, the headset 420 may include contacts 430 for mating with the charging mechanism 410 while the headset 420 is stored within compartment 406. In addition, the headset 420 may include a mechanism for ensuring that the headset 420 remains secured to the computing device while it is stowed, such as a magnetic member (not illustrated) to magnetically attach to a magnetic member disposed within the housing 404 of the computing device. FIG. 4B illustrates the headset 420 stowed away within the housing 404 of the computing device, according to an example. As illustrated, the form factor of the headset 420 may allow for it to blend in with the form factor of the computing device, in order to provide a seamless look. As an example, the headset 420 may include an LED indicator 432, for example, to indicate various conditions regarding the headset 420. For example, if the headset 420 is low on battery, the LED indicator 432 may flash red. In addition, once the headset 420 is stowed away in the housing 404 of the computing device, the LED indicator 432 may flash green until the headset is fully charged.

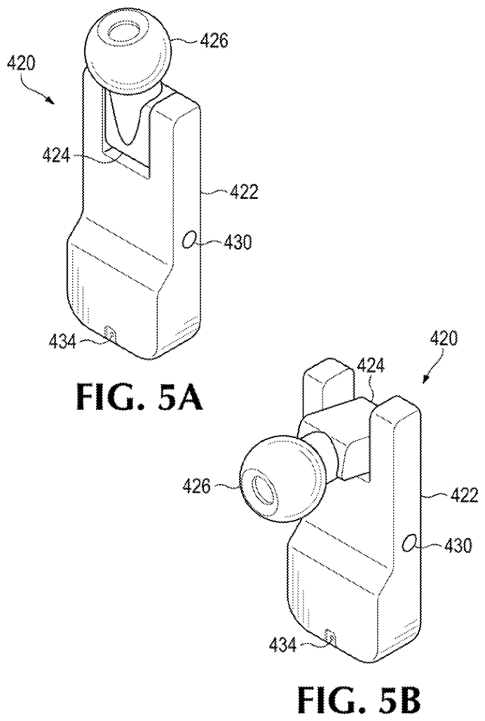

FIGS. 5A-B illustrate the headset 420 switching between an unfolded position and a folded position, according to an example. Referring to FIG. 5A, while in the unfolded position, the second member 424 of the headset 420 may be linearly aligned with the first member 422 of the headset 420. While in the unfolded position, the headset 420 may be stowed away in the housing 404 of the computing device, as will be further described. Referring to FIG. 5B, while in the folded position, the headset 420 may be usable by a user for handsfree communications. For example, the earpiece 426 may be insertable in the ear, and a microphone 434 may be disposed along the first member 422 of the headset 420. The mechanism on the headset 420 for switching between the unfolded and folded positions may vary. For example, the headset 420 may include a hinge between the first member 422 and second member 424 to fold the second member 424 flat (i.e., unfolded position illustrated in FIG. 5A) or to fold the second member 424 to a comfortable position to be utilized by the user (i.e., folded position illustrated in FIG. 5B). Other mechanisms for switching between the unfolded and folded positions include, but are not limited to, a foldable metal. For example, the first and second members 422, 424 may be a single piece that includes a foldable metal to switch between the unfolded and folded positions.

As an example, the headset 420 may include charging contacts 430 to mate with the charging mechanism 410 illustrated in FIG. 4A, in order to keep the headset 420 charged while it is stowed in the housing 404 of the computing device. As a result, rather than relying on a charging cable to charge the headset 420, for example, via a port of the computing device, the port is made available for other uses and the headset 420 can be charged via the charging mechanism 410 while stowed. Placement of the charging mechanism 410 and charging contacts 430 may vary from what is illustrated. For example, the charging contacts 430 may be on either end of the headset 420, and correspond to an appropriately placed charging mechanism 410 within the computing device.

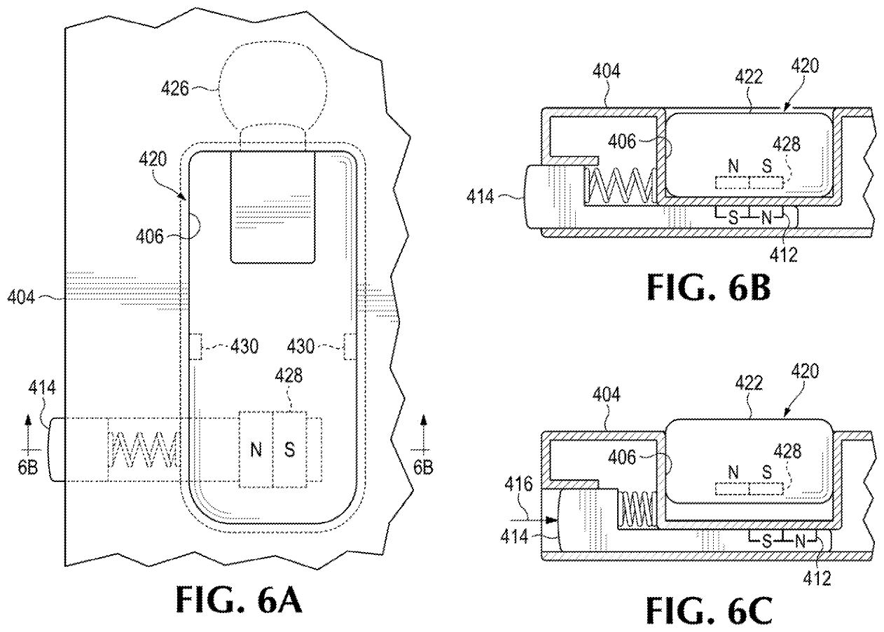

FIGS. 6A-C illustrate a system including the headset 420 and housing 404 of computing device, particularly while the headset 420 is stowed away in the computing device, according to an example. Referring to FIG. 6A, portions of the headset 420 and computing device, particularly housing 404, are illustrated in phantom, to provide details how the headset 420 is secured to the computing device. Referring to FIG. 6B, while in the unfolded position, a magnetic member 412 disposed within the housing 404 of the computing device may be utilized to magnetically attach to magnetic member 428 disposed within the headset 420, while the headset 420 is stowed away in compartment 406. As illustrated, the polarities of magnetic member 412 may be opposite from the polarities of magnetic member 428, so that they magnetically attach to each other. The placement and number of magnetic members utilized between the headset 420 and computing device may vary from what is illustrated.

As an example, the housing 404 of the computing device may include an ejection mechanism 414 for ejecting the headset 420 while it is stowed within the compartment 406. As illustrated, the ejection mechanism 414 may include magnetic member 412. In FIG. 68, while the ejection mechanism 414 is at rest, for example, when the spring illustrated is uncompressed, the polarities of magnetic member 412 may be opposite from the polarities of magnetic member 428, as described above, so that they magnetically attach to each other. However, upon application of the ejection mechanism 414, indicated by arrow 416 in FIG. 6C, magnetic member 412 may be moved over, thereby lining up similar polarities between magnetic member 412 and magnetic member 428 (e.g., S-S, as illustrated). As a result, magnetic members 412, 428 may repel each other, thereby elevating headset 420 from compartment 406, as illustrated in FIG. 6C.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure, Thus, the present disclosure is not intended to be limited to the examples shown herein but is to be accorded the widest scope consistent with the principles and novel features disclosed herein.

What is claimed is:

1. A system comprising:
a headset comprising:
a first member; and
a second member that is foldable with respect to the first member of the headset, between an unfolded position and a folded position; and
a computing device comprising a housing, wherein the housing comprises a compartment for accommodating the headset while in the unfolded position.

2. The system of claim 1, wherein, while in the unfolded position, the second member of the headset is linearly aligned with the first member of the headset.

3. The system of claim 1, wherein the second member of the headset comprises an earpiece that is compressible within the compartment of the computing device during storage of the headset within the compartment.

4. The system of claim 1, wherein the headset is insertable into the compartment of the computing device via the second member of the headset, while in the unfolded position.

5. The system of claim 4, wherein the first member of the headset comprises a first magnetic member to magnetically attach to a second magnetic member disposed within the housing of the computing device, during storage of the headset within the compartment.

6. The system of claim 5, wherein the housing of the computing device comprises an ejection mechanism to eject the headset from within the compartment of the computing device.

7. The system of claim 6, wherein, upon application of the ejection mechanism, the first and second magnetic members are to repel each other.

8. The system of claim 1, wherein the computing device comprises a charging mechanism to charge the headset while it is stored within the compartment of the computing device.

9. A system comprising:
a headset comprising:
a first member; and
a second member that is foldable with respect to the first member of the headset, between an unfolded position and a folded position; and
a computing device comprising a housing, wherein the housing comprises:
a compartment for accommodating the headset while in the unfolded position; and
an ejection mechanism to eject the headset from within the compartment of the computing device.

10. The system of claim 9, wherein the first member of the headset comprises a first magnetic member to magnetically attach to a second magnetic member disposed within the housing of the computing device, during storage of the headset within the compartment.

11. The system of claim 10, wherein, upon application of the ejection mechanism, the first and second magnetic members are to repel each other.

12. The system of claim 9, wherein the computing device comprises a charging mechanism to charge the headset while it is stored within the compartment of the computing device.

13. A system comprising:
a headset comprising:
a first member comprising a first magnetic member; and
a second member that is foldable with respect to the first member of the headset, between an unfolded position and a folded position; and
a computing device comprising a housing, wherein the housing comprises:
a compartment for accommodating the headset while in the unfolded position; and
a second magnetic member disposed within the housing, wherein the first magnetic member is to magnetically attach to the second magnetic member during storage of the headset within the compartment.

14. The system of claim 13, wherein the housing of the computing device comprises an ejection mechanism to eject the headset from within the compartment of the computing device.

15. The system of claim 14, wherein, upon application of the ejection mechanism, the first and second magnetic members are to repel each other.
